(19) United States
(12) Patent Application Publication
(10) Pub. No.: US 2015/0169098 A1
(43) Pub. Date: Jun. 18, 2015

(54) TOUCH PANEL, TOUCH DISPLAY AND MANUFACTURING METHOD OF TOUCH PANEL

(71) Applicant: Innolux Corporation, Chu-Nan (TW)

(72) Inventors: Shu-Fen LI, Chu-Nan (TW); Charles CHIEN, Chu-Nan (TW)

(73) Assignee: Innolux Corporation, Chu-Nan (TW)

(21) Appl. No.: 14/570,334

(22) Filed: Dec. 15, 2014

(30) Foreign Application Priority Data
Dec. 17, 2013 (TW) 102146688

(51) Int. Cl. G06F 3/041

(52) U.S. Cl. CPC G06F 3/041; G06F 2203/04103

(57) ABSTRACT

A touch panel, a touch display and a manufacturing method of a touch panel are provided. The touch panel comprises a first substrate, a touch sensing layer and a decoration layer. The touch sensing layer is disposed on the first substrate. The touch sensing layer comprises a sensing area and a peripheral circuit area adjacent to the sensing area. The decoration layer is disposed on the peripheral circuit area.

This application claims the benefit of Taiwan application Serial No. 102146688, filed Dec. 17, 2013, the subject matter of which is incorporated herein by reference.

### BACKGROUND OF THE INVENTION

1. Field of the Invention

The invention relates in general to a panel, a display device and a manufacturing method of a panel, and more particularly to a touch panel, a touch display and a manufacturing method of a touch panel.

2. Description of the Related Art

Along with the advance and development in technology, various input methods of electronic devices are provided. For example, the invention of touch panel brings huge change to the input methods of electronic devices.

When a user clicks or slides on the touch panel with his/her finger or a stylus, the touch panel senses the user's clicking or sliding and generates a corresponding input signal. The user can write a text, click on an icon or turn over a page on the touch panel in an intuitive manner.

Since the user has to touch the touch panel with his/her finger or a stylus, the touch panel is normally equipped with a cover glass on which the user directly touches. Elements such as touch sensing layer are disposed underneath the cover glass which is disposed on the outmost part of the touch panel. Therefore, how to improve the strength of the cover glass is a crucial technology to the touch panel.

Besides, a number of traces are disposed on a peripheral circuit area of the touch panel and extend to a sensing area. In order to shield the traces disposed on the peripheral circuit area to prevent the circuit from being seen by the user, black matrixes are printed on the part which is on the back of the cover glass (not the user contact surface) and corresponds to the peripheral traces of the touch panel to shield the traces. The touch panel and the cover glass are two independent elements and are normally bonded together by using an adhesive. However, if the alignment precision in the bonding process is not sufficient, the black matrixes cannot completely shield the traces or may shield part of the sensing area. Therefore, how to improve the alignment precision of the black matrixes on the cover glass is another crucial technology to the touch panel.

### SUMMARY OF THE INVENTION

The invention is directed to a touch panel, a touch display and a manufacturing method of a touch panel, which enhances the alignment precision and substrate strength by directly disposing a decoration layer on a stacking structure of a touch sensing layer instead of screen printing the decoration layer on the back of a cover glass.

According to one embodiment of the present invention, a touch panel is provided. The touch panel comprises a first substrate, a touch sensing layer and a decoration layer. The touch sensing layer is disposed on the first substrate. The touch sensing layer comprises a sensing area and a peripheral circuit area adjacent to the sensing area. The decoration layer is disposed on the peripheral circuit area.

According to another embodiment of the present invention, a touch display is provided. The touch display comprises a display device and a touch panel. The touch panel is disposed on the display surface. The touch panel comprises a first substrate, a touch sensing layer and a decoration layer. The touch sensing layer is disposed on the first substrate. The touch sensing layer comprises a sensing area and a peripheral circuit area adjacent to the sensing area. The decoration layer is disposed on the peripheral circuit area.

According to an alternate embodiment of the present invention, a manufacturing method of a touch panel is provided. The manufacturing method of the touch panel comprises following steps. A first substrate is provided. A touch sensing layer comprising a sensing area and a peripheral circuit area adjacent to the sensing area is formed on the first substrate. A decoration layer is formed on the peripheral circuit area.

The above and other aspects of the invention will become better understood with regard to the following detailed description of the preferred but non-limiting embodiment (s). The following description is made with reference to the accompanying drawings.

### BRIEF DESCRIPTION OF THE DRAWINGS

FIG. 1A is a top view of a touch panel according to a first embodiment.

FIG. 1B is a cross-sectional view along a cross-sectional line B-B′ of the touch panel of FIG. 1A.

FIG. 2 is a cross-sectional view of a touch panel according to a second embodiment.

FIG. 3 is a cross-sectional view of a touch panel according to a third embodiment.

FIG. 4 is a cross-sectional view of a touch panel according to a fourth embodiment.

FIG. 5 is a flowchart of a manufacturing method of a touch panel.

FIGS. 6A to 6H show procedures of the steps of FIG. 5.

FIG. 7 is a flowchart of a cutting method of a second substrate.

FIG. 8 is a schematic diagram of a touch display according to an embodiment of the disclosure.

FIG. 9 is a schematic diagram of a touch display according to another embodiment of the disclosure.

### DETAILED DESCRIPTION OF THE INVENTION

A number of embodiments are disclosed below with accompanying drawings for elaborating the invention. The alignment precision and substrate strength are enhanced by directly disposing an decoration layer on a stacking structure of a touch sensing layer instead of screen printing the decoration material on another substrate. However, the embodiments of the invention are for detailed descriptions only, not for limiting the scope of protection of the invention.

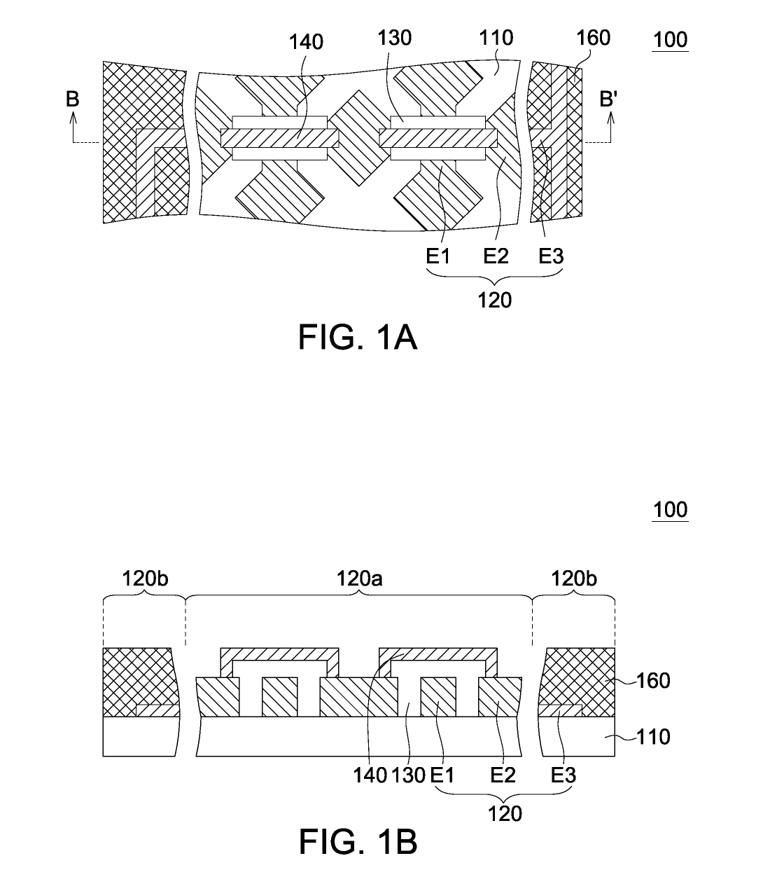

Refer to FIGS. 1A to 1B. FIG. 1A is a top view of a touch panel 100 according to a first embodiment. FIG. 1B is a cross-sectional view along a cross-sectional line B-B′ of the touch panel 100 of FIG. 1A. The touch panel 100 of the present embodiment comprises a first substrate 110, a touch sensing layer 120 and a decoration layer 160. The first substrate 110 can be realized by such as a glass substrate. The touch panel 100 can be configured in a display panel (not illustrated), such that the user can initiatively perform touch operation on the display panel through the touch panel 100. By this way, the first substrate 110 can be realized by a transparent glass substrate.

The touch sensing layer 120 is disposed on the first substrate 110. The touch sensing layer 120 adopts capacitive sensing or resistive sensing, such that when the user touches the touch panel 100 with his/her finger or a stylus, the position at which the user touches can be detected through variation in resistance or capacitance. The touch sensing layer 120 can be made of a transparent electrode material such as indium tin oxide (ITO) or indium zinc oxide (IZO).

The touch sensing layer 120 comprises a sensing area 120a and a peripheral circuit area 120b adjacent to the sensing area 120a. That is, the peripheral circuit area 120b is in a peripheral area of the sensing area 120a. The sensing area 120a has a plurality of first direction sensing electrodes E1 and second direction sensing electrodes E2. The peripheral circuit area 120b has a plurality of peripheral circuits E3, which electrically connect the first direction sensing electrodes E1 and the second direction sensing electrodes E2 of the sensing area 120a for transmitting the signals of the sensing area 120a to the exterior. In the present embodiment, the first direction sensing electrodes E1 and the second direction sensing electrodes E2 are designed as a single ITO layer and are disposed on the same side of the first substrate 110, wherein the first direction is different from the second direction. The sensing area 120a further comprises a spacer layer 130 and a bridging layer 140. The spacer layer 130 separates the first direction sensing electrodes E1 from the second direction sensing electrodes E2 such that the first direction sensing electrodes E1 and the second direction sensing electrodes E2 are electrically insulated from each other. The bridging layer 140 is disposed on the spacer layer 130 and located at the junction between the first direction sensing electrodes E1 and the second direction sensing electrodes E2. The bridging layer 140 bridges over the first direction electrodes E1 or the second direction electrodes E2 of the same direction to avoid the electrodes of different directions being short-circuited. The bridging layer 140 can be made of a transparent conductive material or a non-transparent conductive material.

The decoration layer 160 is disposed on the peripheral circuit area 120b to shield the structure in the peripheral circuit area 120b of the touch sensing layer 120. The decoration layer 160 can directly cover the peripheral circuit area 120b and directly contact the peripheral circuits E3. The material of the decoration layer 160 is selected from a group consisting of photoresist material, ink material, metal material and a combination thereof. The decoration layer 160 can be made of a dark-colored material whose color is black, blue or red used for forming a black matrix or made of silver or copper. The decoration layer 160 prevents the structure in the peripheral circuit area 120b of the touch sensing layer 120 from being seen by the user and at the same time allows the frame of the touch panel 100 to have different colors and patterns so as to meet users' requirements of appearance. The decoration layer 160 together with the touch sensing layer 120 can be directly formed by using a continuous process, such as developing and exposure process, or by a coating process.

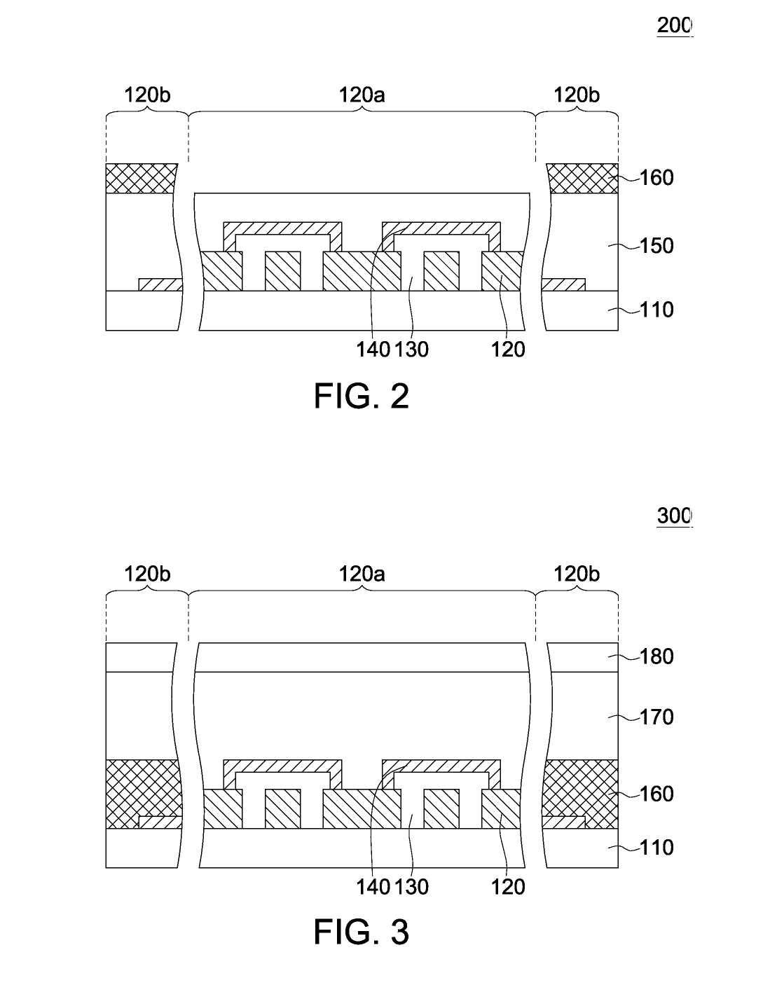

Referring to FIG. 2, a cross-sectional view of a touch panel 200 according to a second embodiment is shown. In comparison to the touch panel 100 of the first embodiment, the touch panel 200 of the present embodiment further comprises an insulation layer 150. The insulation layer 150 is disposed on the touch sensing layer 120 and between the decoration layer 160 and the peripheral traces E3 and directly covers the touch sensing layer 120 and the peripheral traces E3 to avoid unexpected short-circuiting and mitigate external moisture and particles affecting the touch sensing layer 120 and the peripheral traces E3. The decoration layer 160 corresponds to the peripheral circuit area 120b and covers the insulation layer 150.

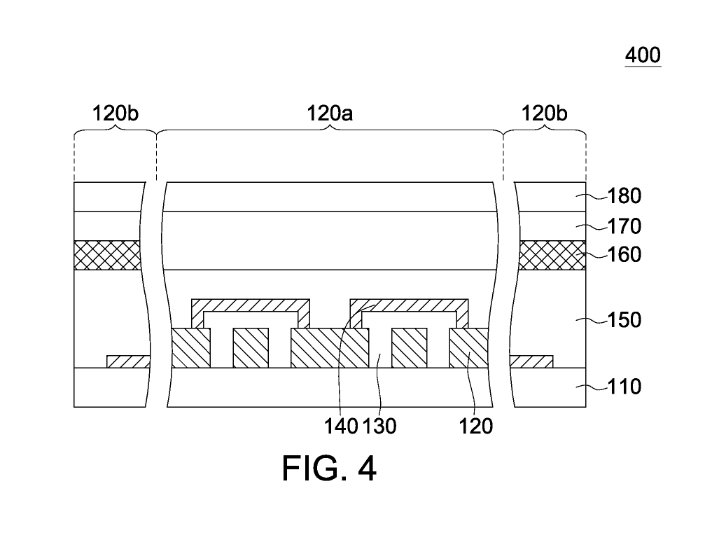

Referring to FIG. 3, a cross-sectional view of a touch panel 300 according to a third embodiment is shown. In comparison to the touch panel 100 of the first embodiment, the touch panel 300 of the present embodiment further comprises an adhesive layer 170 and a second substrate 180. The adhesive layer 170 is located between the decoration layer 160 and the second substrate 180. In the present embodiment, the adhesive layer 170 covers the decoration layer 160 and the touch sensing layer 120, and the second substrate 180 is bonded onto the adhesive layer 170. That is, the adhesive layer 170 is directly adhered on the decoration layer 160, the touch sensing layer 120 and the second substrate 180, such that internal components of the touch panel 300 are interposed between the second substrate 180 and the first substrate 110. The adhesive layer 170 is made of such as optical clear resin (OCR) or optically clear adhesive (OCA). The first substrate 110 and the second substrate 180 can be made of such as plastics or glass. In the present embodiment, the second substrate 180 is a cover glass.

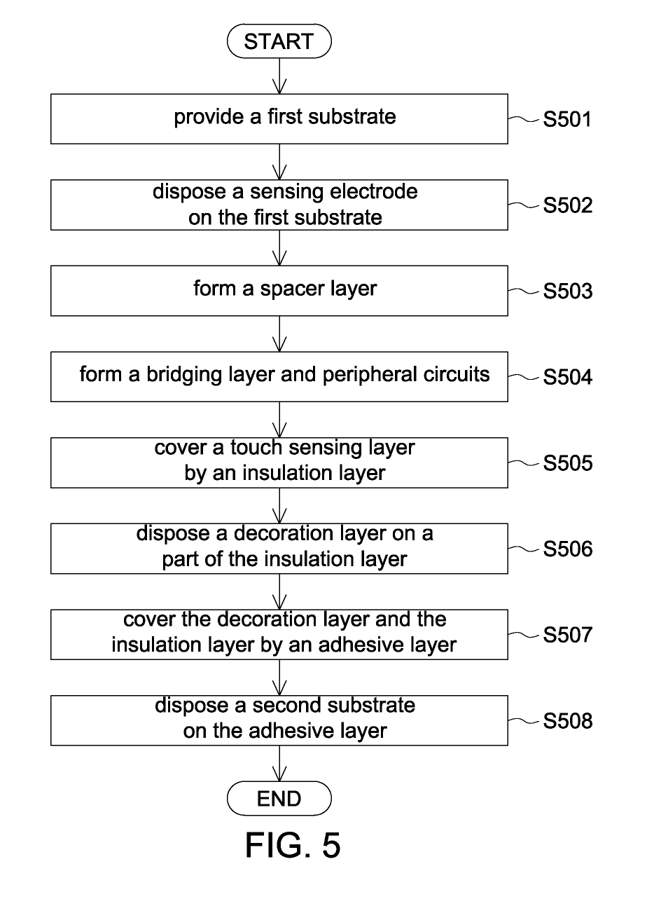

Referring to FIG. 4, a cross-sectional view of a touch panel 400 according to a fourth embodiment is shown. In comparison to the touch panel 200 of the second embodiment, the touch panel 400 of the present embodiment further comprises an adhesive layer 170 and a second substrate 180. The adhesive layer 170 covers the decoration layer 160 and the insulation layer 150, and the second substrate 180 is bonded onto the adhesive layer 170. That is, the adhesive layer 170 is directly adhered on the decoration layer 160, the insulation layer 120 and the second substrate 180, such that internal components of the touch panel 400 are interposed between the second substrate 180 and the first substrate 110.

Of the components disclosed above, the first substrate 110, the touch sensing layer 120, the spacer layer 130, the insulation layer 150, the adhesive layer 170 and the second substrate 180 are normally made of a transparent material such that the touch panels 100, 200, 300, and 400 are permeable to the light. Thus, when the touch panels 100, 200, 300 and 400 are disposed on the display panel (not illustrated), the user still can see the frame of the display panel and can directly perform various operations on the frame. Due to the consideration of the appearance design which avoids the non-transparent structure (the peripheral traces E3) of the peripheral circuit area 120b being viewed by the user directly, the non-transparent structure (the peripheral traces E3) of the peripheral circuit area 120b is shielded by the decoration layer 160. Through the selection of material color and pattern design, the decoration layer 160 can provide versatile change to the display device having the touch panels 100, 200, 300, and 400.

Refer to FIG. 2 and FIG. 4. The decoration layer 160 directly contacts the insulation layer 150. The decoration layer 160 and the insulation layer 150 are bonded without using the adhesive layer 170. That is, there is no gap between the decoration layer 160 and the insulation layer 150.

The second substrate 180 and the decoration layer 160 may be separated by a gap. The decoration layer 160 is not directly screen printed on the second substrate 180. The second substrate 180 and the decoration layer 160 are bonded by a part of the adhesive layer 170.

In an embodiment, the second substrate 180 may contact the decoration layer 160 without having any gaps if the adhesive layer 170 has a small amount of adhesive.

Additionally, a thickness of the decoration layer 160 is less than a maximum of a thickness of the adhesive layer 170, such that the adhesive layer 170 may cover the decoration layer 160.

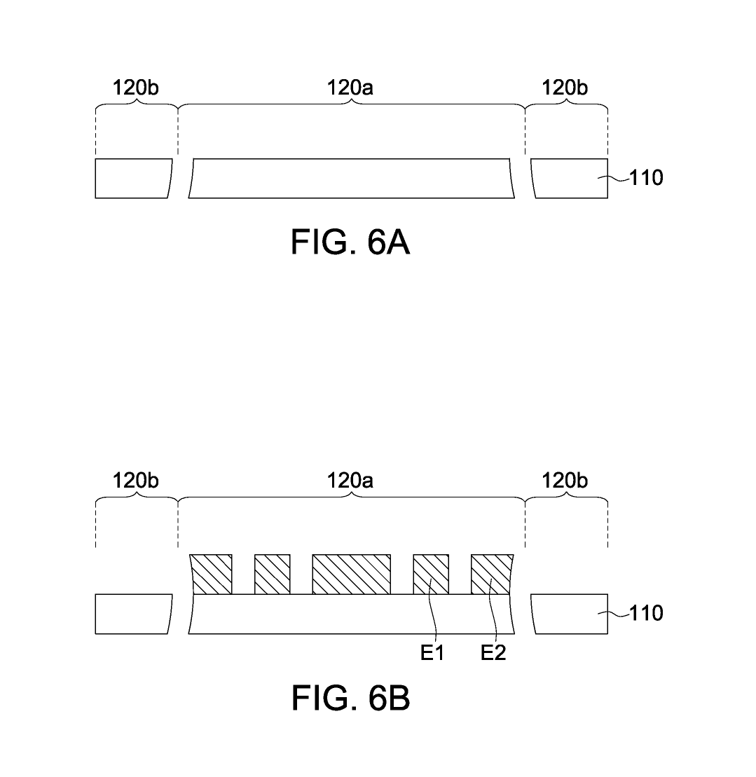

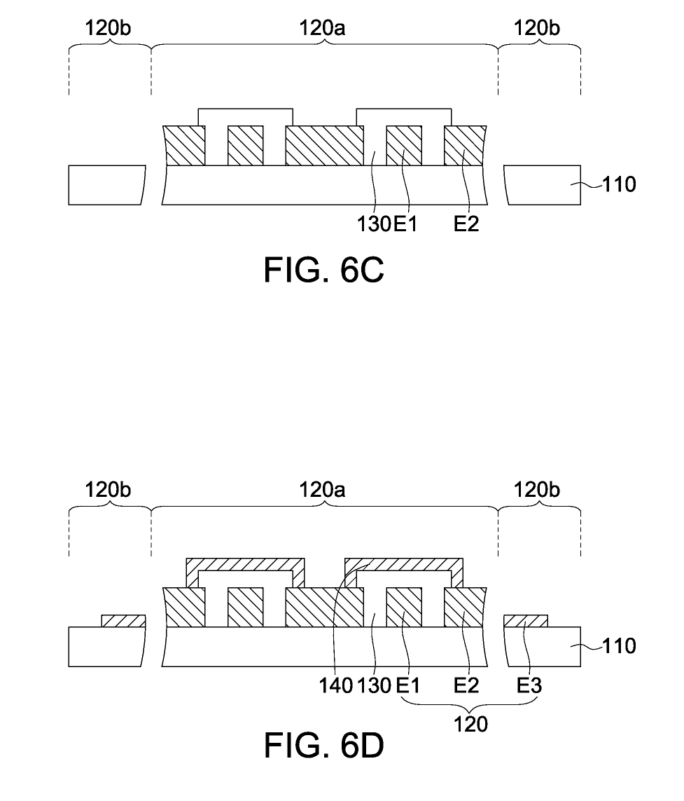

Refer to FIG. 5 and FIGS. 6A to 6H. FIG. 5 is a flowchart of a manufacturing method of the touch panel 400 of the fourth embodiment. FIGS. 6A to 6H show procedures of the steps of FIG. 5. The manufacturing method of the fourth embodiment is exemplified below. The manufacturing method of other embodiments can have more or fewer steps than the manufacturing method of the fourth embodiment depending on the difference in structure, and the steps common to the manufacturing method of the fourth embodiment and the manufacturing method of other embodiments are not repeated here. Firstly, the method begins at step S501 as indicated in FIG. 6A, the first substrate 110 is provided. The first substrate 110 can be realized by such as a transparent glass substrate. The first substrate 110 has the sensing area 120a and the peripheral circuit area 120b.

Then, the method proceeds to step S502 as indicated in FIG. 6B, a number of sensing electrodes are disposed on the sensing area 120a of the first substrate 110. In the present step, the sensing electrodes can be evaporated on the sensing area 120a of the first substrate 110 by using an evaporation process, and then the sensing electrode layer is etched into the first direction sensing electrodes E1 and the second direction sensing electrodes E2 by using an etching process. The first direction sensing electrodes E1 and the second direction sensing electrodes E2 can be disposed on the same layer or can be stacked on different layers.

Then, the method proceeds to step S503 as indicated in FIG. 6C, the spacer layer 130 is formed such that the first direction sensing electrodes E1 and the second direction sensing electrodes E2 are electrically insulated from each other. In the present step, the spacer layer 130 can be formed by using a deposition, an exposure, a developing or an etching process.

Then, the method proceeds to S504 as indicated in FIG. 6D, the bridging layer 140 and the peripheral circuits E3 are formed at the same time. The bridging layer 140 is disposed on the spacer layer 130 to connect the first direction sensing electrodes E1 or the second direction sensing electrodes E2 of the same direction. The peripheral circuits E3 are disposed on the peripheral circuit area 120b to electrically connect the first direction sensing electrodes E1 or the second direction sensing electrodes E2 for guiding the signals of the touch sensing layer 120 to the exterior. In the present step, the bridging layer 140 and peripheral circuits E3 can be formed by using a deposition, an exposure, a developing or an etching process. In an embodiment, the bridging layer 140 disposed on the spacer layer 130 and the peripheral circuits E3 disposed on the peripheral circuit area 120b can be made of different materials.

The above steps S502 to S505 are for forming the touch sensing layer 120 on the first substrate 110.

Then, the method proceeds to step S505 as indicated in FIG. 6E, the insulation layer 150 covers the touch sensing layer 120. In the present step, the insulation layer 150 can be formed by using a deposition process.

Then, the method proceeds to step S506 as indicated in FIG. 6F, the decoration layer 160 is disposed on a part of the insulation layer 150. That is, the decoration layer 160 corresponds to the insulation layer 150 of the peripheral circuit area 120b to shield the structure on the peripheral circuit area 120b of the touch sensing layer 120. In the present step, the entire decoration layer 160, made of a photoresist material, is coated on the insulation layer 150 first, and is subsequently processed with a patterning exposure process. Then, the decoration layer 160 is processed with a patterning developing process.

Then, the method proceeds to step S507 as indicated in FIG. 6G, the adhesive layer 170 covers the decoration layer 160 and the insulation layer 150.

Then, the method proceeds to step S508 as indicated in FIG. 6H, the second substrate 180 is bonded onto the adhesive layer 170. Thus, the touch panel 400 of the fourth embodiment is completed.

In an embodiment, the adhesive layer 170 can be disposed on the second substrate 180 first, and then the second substrate 180 with the adhesive layer 170 is bonded onto the decoration layer 160 and the insulation layer 150.

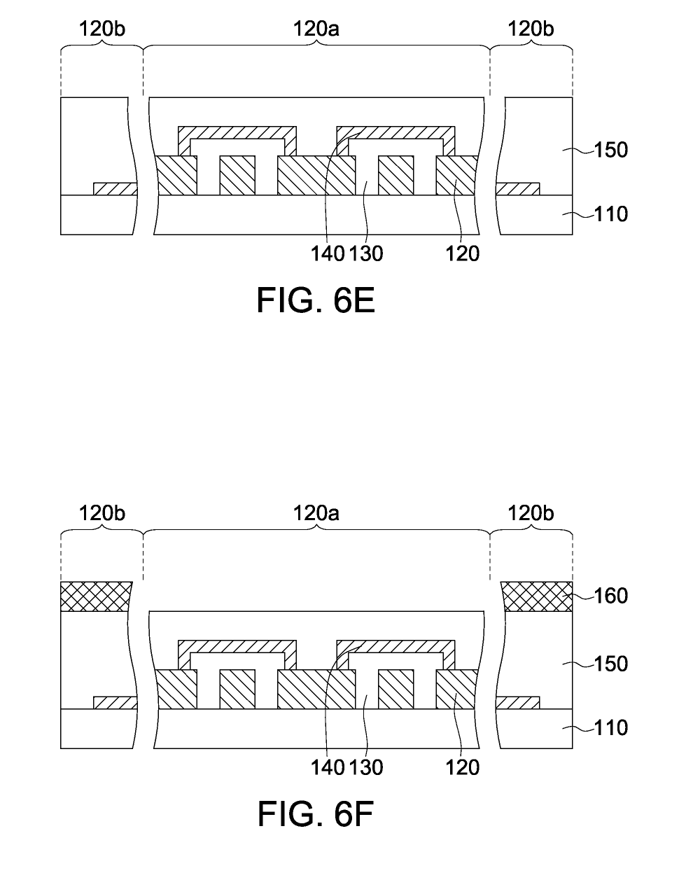

Referring to FIG. 7, a flowchart of a cutting method of a second substrate 180 is shown. In the present embodiment, the decoration layer 160 directly is disposed on the stacking structure of the touch sensing layer 120 instead of being screen printed on the second substrate 180. Therefore, there is no need to consider the decoration layer 160 in the cutting process of the second substrate 180. In step S701, the second substrate 180 is provided, wherein the provided second substrate 180 is a large motherboard. Next, the method proceeds to step S702, the second substrate 180 is processed with a cutting process in which the second substrate 180 is cut into a smaller substrate. Then, the method proceeds to step S703, the second substrate 180 is processed with a grinding process in which the saw-teeth off the cutting edge is removed. Then, the method proceeds to step S704, the hardness of the second substrate 180 is processed with a glass reinforcement process in which the hardness of the second substrate 180 is enhanced. Lastly, the method proceed to step S705, the second substrate 180 is completed.

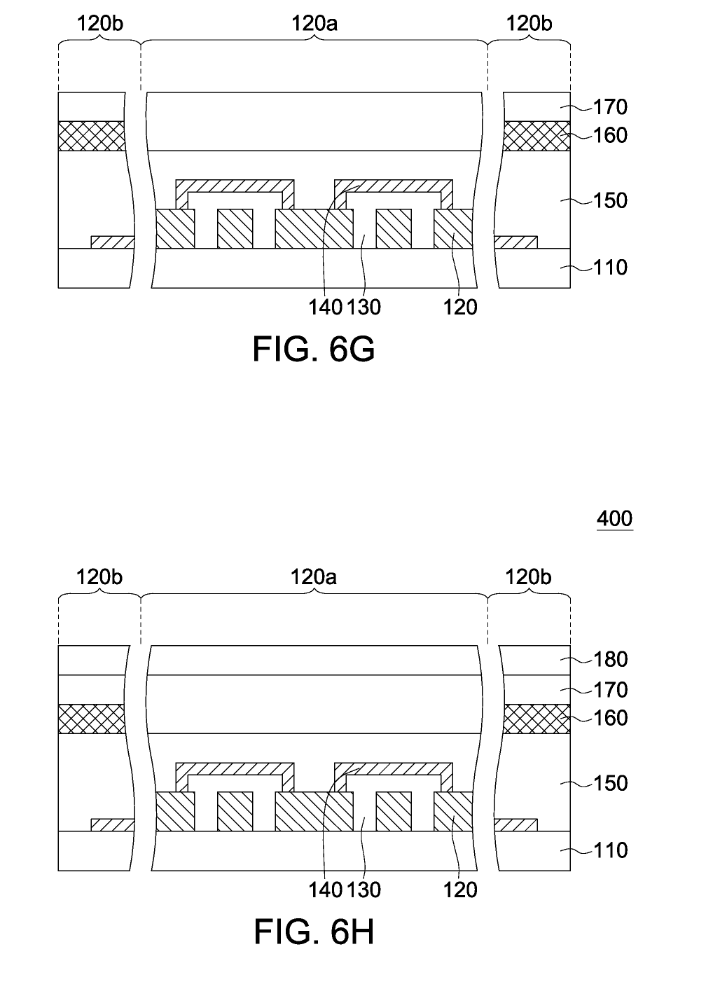

Referring to FIG. 8, a schematic diagram of a touch display 1000 according to an embodiment of the disclosure. The touch display 1000 of the disclosure comprises a display device 800 having a display surface 811 and the touch panel 100, wherein the touch panel 100 is disposed on the display surface 811 of the display device 800. The touch panel 100 is bonded onto the display surface 811 of the display device 800 by an adhesive 600 or other means.

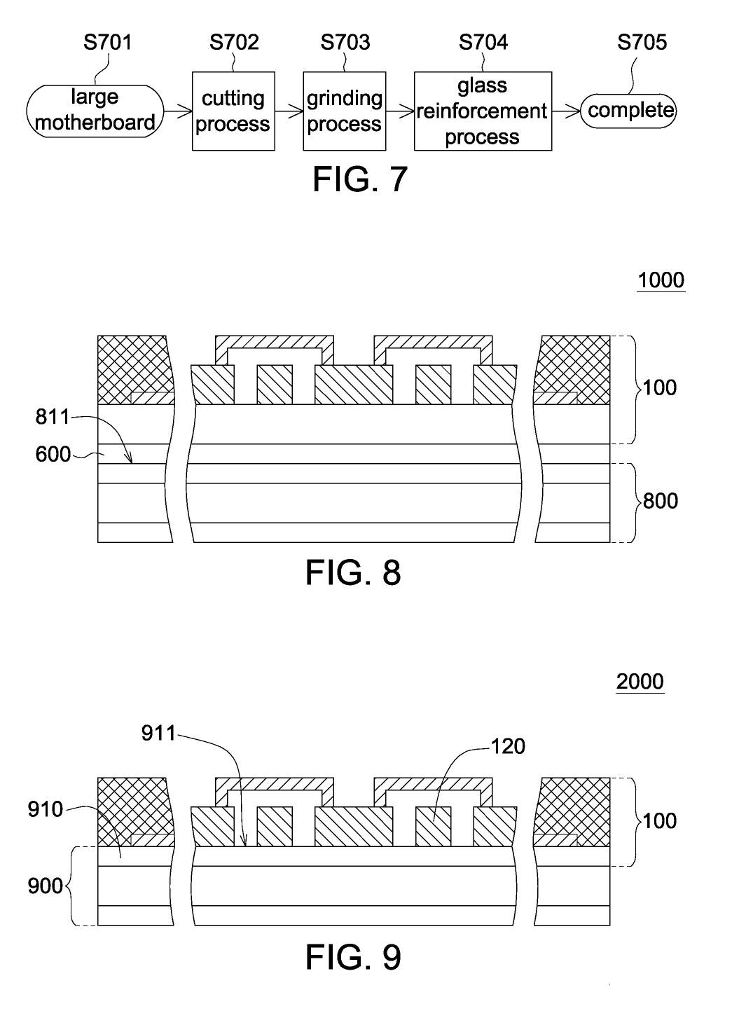

Referring to FIG. 9, a schematic diagram of a touch display 2000 according to another embodiment of the disclosure is shown. The touch display 2000 of the present embodiment is different from the touch display 1000 in that the display panel 910 of the display device 900 is used as the first substrate 110 of the touch panel 100, and the touch sensing layer 120 is directly formed on the display surface 911 of the display panel 910. By doing so, the touch panel 100 can be dispensed with the first substrate 110 (illustrated in FIG. 1B), such that the cost can be reduced and the touch panel 100 can be further thinned.

In the present embodiment, the decoration layer 160 is not screen printed on the second substrate 180 but is formed on the first substrate 110 having the touch sensing layer 120 by using a patterning process, such that the decoration layer 160 can have higher alignment precision. Moreover, in the present embodiment, the second substrate 180 is down-sized and reinforced to reduce the strength loss which occurs during the grinding process.

While the invention has been described by way of example and in terms of the preferred embodiment (s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A touch panel, comprising:
a first substrate;
a touch sensing layer disposed on the first substrate, wherein the touch sensing layer comprises:
a sensing area; and
a peripheral circuit area adjacent to the sensing area; and
a decoration layer disposed on the peripheral circuit area.

2. The touch panel according to claim 1, further comprising:
a second substrate disposed on the decoration layer; and
an adhesive layer located between the decoration layer and the second substrate.

3. The touch panel according to claim 2, wherein the adhesive layer is directly adhered on the decoration layer and the second substrate.

4. The touch panel according to claim 2, wherein the second substrate and the decoration layer are separated by a gap to which the adhesive layer is interposed.

5. The touch panel according to claim 2, wherein a thickness of the decoration layer is less than a maximum of a thickness of the adhesive layer.

6. The touch panel according to claim 1, wherein a material of the decoration layer is selected from a group consisting of a photoresist material, an ink material, a metal material and a combination thereof.

7. The touch panel according to claim 1, wherein the first substrate is a display panel of a display device.

8. A touch display, comprising:
a display device having a display surface; and
a touch panel according to claim 1, wherein the touch panel is disposed on the display surface.

9. A manufacturing method of a touch panel, comprising:
providing a first substrate;
forming a touch sensing layer on the first substrate, wherein the touch sensing layer comprises a sensing area and a peripheral circuit area adjacent to the sensing area; and
forming a decoration layer on the peripheral circuit area.

10. The manufacturing method of the touch panel according to claim 9, further comprising:
forming an adhesive layer on the decoration layer; and
disposing a second substrate on the adhesive layer.
